(19) United States
(12) Patent Application Publication
(10) Pub. No.: US 2024/0319345 A1
(43) Pub. Date: Sep. 26, 2024

(54) ELECTRONIC DISTANCE METER

(71) Applicant: Trimble Inc., Westminster, CO (US)

(72) Inventor: Rémi Dobin, Danderyd (SE)

(73) Assignee: Trimble Inc., Westminster, CO (US)

(21) Appl. No.: 18/680,061

(22) Filed: May 31, 2024

Related U.S. Application Data
(63) Continuation of application No. PCT/EP2021/084159, filed on Dec. 3, 2021.

(51) Int. Cl. G01S 7/4865; G01S 7/481; G01S 17/10

(52) U.S. Cl. CPC G01S 7/4865; G01S 7/4814; G01S 7/4816; G01S 17/10

(57) ABSTRACT

Electronic distance meter comprising a laser (4) emitting a laser pulse toward a target (12), a photodetector (6) adapted for receiving a laser pulse reflected by the target (12) and for outputting a corresponding return pulse signal, and a comparison circuit (8) receiving said return pulse signal and comprising a passive signal processing circuit (20) and a comparator (22) provided with a first input and a second input and arranged to output a first fixed value signal when the signal at the first input exceeds the signal at the second input and else to output a second fixed value signal, said comparison circuit (8) being arranged for determining a return pulse time signal based on the output of said comparator (22), said electronic distance meter being arranged for determining a target distance based on said return pulse time signal, wherein said passive signal processing circuit (20) comprises a first branch receiving said return pulse signal and comprising a transmission line (34) for generating a first twinset signal (24) to said first input, and a second branch receiving said return pulse signal and comprising a transmission line (36) and a delay line (38) for generating a second twinset signal (24) to said second input, the transmission lines (34, 36) being chosen such that each twinset signal respectively comprises a positive and negative alternating portion which substantially corresponds to a first order derivative of the return pulse signal.

### CROSS-REFERENCES TO RELATED APPLICATIONS

This application is a continuation of International Application No. PCT/EP2021/084159, filed Dec. 3, 2021, the entire contents of which are incorporated herein by reference for all purposes.

### FIELD OF TECHNOLOGY

The invention concerns the field of range finding, and more particularly the field a laser-based electronics distance meters (EDM) dedicated to high precision Time Of Flight (TOF) measurement between two fine or larger optical pulses

### BACKGROUND OF THE INVENTION

Such telemeters include laser rangefinders (3D scanners, Total stations), handheld laser distance meters, LIDAR, SLAM and global mapping applications and other laser based TOF distance measurement device. Laser implemented in such devices, generally emits a short laser pulse called “start pulse” to enlighten a target. A reflected part of that laser pulse is sent back by the target towards the device in the form of a short pulse called “stop pulse”.

The time interval between the start and stop pulses provides with the distance between the device and the target. The start and stop pulses have to be converted efficiently into electrical pulses so that the time position information of each is not significantly degraded to reach the wanted precision. The start and stop electrical pulses are both processed in a front-end EDM dedicated to TOF measurement.

Several solutions have been developed in order to achieve the conversion of the start and stop pulses.

The first category of solutions is based on precise digital sampling of the pulses, using barycenter algorithm coded in a FPGA. However, achieving a millimeter precision requires determining the pulses times with a precision of the order of 10 picoseconds. This necessitates a fast ADC (Analog to Digital Converter), which makes this solution extremely unattractive in terms of cost.

The second category of solutions is based on a threshold comparison to provide for cheaper precise pulse time detection. More precisely, the pulse is fed into a comparator against a pulse threshold. When the pulse is below the threshold, the output value is at a first fixed value. When the pulse exceeds the threshold, the output is set to a second fixed value. The pulse time position can be identified as the transition moment from the first fixed value to the second fixed value. However, depending on the brightness of the pulse and on the background noise (both at the pulse level and the comparator level), there is an uncertainty in the pulse time detection which is known as time walk. The time walk of these solutions is incompatible with millimeter precision devices, and cannot be conveniently corrected by conventional feedback or compensation techniques.

Several methods have been implemented to improve the accuracy of this determination using techniques like constant fraction discriminator (CFD). However, they imply using active components, which have their own noise and add to the uncertainty of the determination.

There is thus a need for a submillimeter precision EDM working with short or longer pulses (about 1 ns), delivering walk time independent time position and luminance information, while remaining high speed, real time and cost effective and with a very small footprint.

### BRIEF SUMMARY OF THE INVENTION

The invention improves the situation by providing an electronic distance meter comprising a laser emitting a laser pulse toward a target, a photodetector adapted for receiving a laser pulse reflected by the target and for outputting a corresponding return pulse signal, and a comparison circuit receiving said return pulse signal and comprising a passive signal processing circuit and a comparator provided with a first input and a second input and arranged to output a first fixed value signal when the signal at the first input exceeds the signal at the second input and else to output a second fixed value signal. Said comparison circuit is arranged for determining a return pulse time signal based on the output of said comparator, said electronic distance meter is arranged for determining a target distance based on said return pulse time signal. Said passive signal processing circuit comprises a first branch receiving said return pulse signal and comprising a transmission line for generating a first twinset signal to said first input, and a second branch receiving said return pulse signal and comprising a transmission line and a delay line for generating a second twinset signal to said second input, the transmission lines being chosen such that each twinset signal respectively comprises a positive and negative alternating portion which substantially corresponds to a first order derivative of the return pulse signal.

This device is advantageous because it employs passive differentiators that behave like derivators combined with a way to get rid of the background comparator input noise that is outside the useful signal frequency range. As a result, this device provides an EDM that has an extremely flat distance response over an extremely wide luminance amplitude range, which is both cost effective and even more precise than known solutions in resolution with nanosecond pulses.

Various embodiments according to the invention may comprise one or more of the following features:
said delay line has a delay value chosen such that the rising edge of the signal of said transmission line of said second branch crosses the trailing edge of the signal of said transmission line of said first branch in a region,
said transmission lines are realized by means of a single track or by means of discrete parts,
said single track includes a microstrip or a stripline and said discrete parts include capacitors and inductances,
said delay line is realized by means of inductance-capacitor cells connected in series,
said first branch comprises a passive element for impedance matching of the transmission line,
said second branch comprises a passive element for impedance matching of the transmission line,
said second branch comprises passive elements for impedance matching of the delay line, and
said delay line has a delay value chosen such that the rising edge of the signal of said transmission line of said second branch crosses the trailing edge of the signal of said transmission line of said first branch in a region where both the rising edge and the trailing edge have substantially a maximum first order derivative.

The invention also concerns a method for measuring a distance, comprising:
a) emitting a laser pulse toward a target,
b) generating a return pulse signal based on a laser pulse reflected by the target,
c) generating a first twinset signal and a second twinset signal derived from the return pulse signal, using a transmission line for said first twinset signal, and using a transmission line and a delay line for said second twinset signal, said transmission lines being chosen such that each twinset signal respectively comprises a positive and negative alternating portion which substantially corresponds to a first order derivative of the return pulse signal,
d) generating a return pulse time signal based on a comparison between said first twinset signal and said second twinset signal, said return pulse time signal being equal to a first fixed value when said first twinset signal exceeds said second twinset signal and equal to a second fixed value otherwise, and
e) determining a target distance based on said return pulse time signal.

According to this method, operation c) may include said delay line has a delay value chosen such that the rising edge of the signal of said transmission line of said second branch crosses the trailing edge of the signal of said transmission line of said first branch in a region.

### BRIEF DESCRIPTION OF THE DRAWINGS

Other features and advantages of the invention will readily appear in the following specification, which describes examples taken from the drawings in a non-limiting manner. The drawings are intended to help better understand the invention by way of illustration, but may also be used to define it if necessary. On these drawings:

FIG. 1 shows a generic representation of an electronic distance meter according to the invention,

FIG. 2 shows a representation of a comparison circuit 8 of FIG. 1 according to a first embodiment of the invention,

FIG. 3 shows a representation of a passive signal processing circuit of FIG. 2 according to a first embodiment,

FIG. 4 shows a representation of an input signal, and a corresponding twinset signal,

FIG. 5 shows a pulse having a first, smaller width, and the same pulse reflected by a passive delay line of opposite sign,

FIG. 6 shows the combination of incident and reflected pulse for each channel (referred to hereinafter as “twinset”), one channel being delayed as compared to the other,

FIG. 7 shows the effect of the variation of the amplitude of the incident pulse of FIG. 6,

FIG. 8 shows a pulse having a second, larger width, and the same reflected by a passive delay line of opposite sign,

FIG. 9 shows the combination of incident and reflected pulse for each channel (also called “a twinset”), one channel being delayed as compared to the other,

FIG. 10 shows a representation of a passive signal processing circuit of FIG. 2 according to a second embodiment, and

FIG. 11 shows a representation of a passive signal processing circuit of FIG. 2 according to a first embodiment.

### DETAILED DESCRIPTION OF THE INVENTION

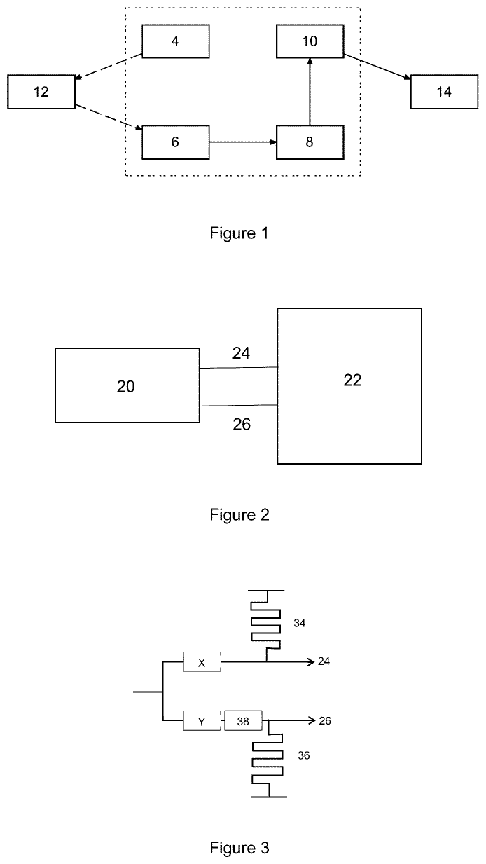

FIG. 1 shows a generic representation of an electronic distance meter (EDM) 2 according to the invention. EDM 2 comprises a light source 4, a photodetector 6, a comparison circuit 8 and a processor 10.

The EDM 2 may be a laser rangefinder (a 3D scanner or a total station), a handheld laser distance meter, a LIDAR, a SLAM device or any other laser based TOF distance measurement device. The light source 4 will be adapted according to the telemeter type. In the examples described below, the light source 4 is able to output light pulses having a width of the order of 1 ns, in order to be able to achieve sub-millimeter precision. The photodetector 6 may also be chosen according to the type of EDM elected. In view of the light source 4 used, it will need a convenient bandwidth to manage nanosecond or sub nanosecond pulse width.

The comparison circuit 8 may be realized by any suitable architecture, such as a circuit board, an ASIC or an FPGA or any other means suitable for implementing its architecture and functions as described herein below.

The processor 10 may be any type of processing capable element adapted to perform the calculus and operations described herein. It may be a general-purpose microprocessor for personal computers, graphic cards or other electronic devices, a specialized chip such as a FPGA or a SoC (System on Chip), a computing source in a grid, a microcontroller, an ASIC or any other element capable of providing the computing power for those calculus and/or operations. One or more of the elements may be combined, including with part or whole of the comparison circuit 8.

According to the invention, the light source 4 emits a laser beam onto a target 12. Target 12 thereafter reflects a return pulse onto the photodetector 6. The output of photodetector 6 is fed to the comparison circuit 8, which outputs a trigger. The trigger is a step signal which transition brings the wanted time position information. The processor 10 receives the return pulse time signal and determines distance data 14 between the target 12 and the EDM 2.

FIG. 2 represents a general view of the comparison circuit 8 of FIG. 1 according to a first embodiment of the invention. The comparison circuit 8 comprises a passive signal processing circuit 20 and a comparator circuit 22.

The passive processing circuit 20 may be realized by any means available, be it a set of passive components like resistors, delay and transmission lines or any other suitable mean for producing respectively at its two outputs two twinset signals referenced 24 and 26. Passive processing circuit 20 is designed such that signals 24 and 26 are slightly delayed with respect to one another, the value of that delay being part of the design. As will appear further below, this delay allows to perform the precise detection of the pulses.

The comparator 22 receives the twinset signal 24 at a first input, and the second twinset signal 26 at a second input. The comparator 22 is such that its output toggles from a first fixed value signal to a second fixed value signal when the signal at the first input exceeds the signal at the second input. The comparator 22 is such that the trigger toggling transition is fast enough to preserve the wanted time position precision.

A small offset may be introduced between either the two twinset signals 24 and 26 or the two comparator inputs by an external biasing circuit. This small offset is useful to set the comparator output at a well-defined state before detection and after detection. This offset will however introduce a small distortion in the time position of the output time signal for the lowest input signals, however without compromising noise budget nor signal spectral content.

In the example described herein, the first fixed value is “low”, and the second fixed value is “high”. In other embodiments, the first fixed value and the second fixed value may be set differently, as long as they allow the processor 10 to properly determine the time associated with the return pulse for TOF measurement. To achieve the best performances, an ultrafast voltage comparator having a bandwidth greater than 1 GHz fabricated in Silicon Germanium (SiGe) bipolar process can be used. It may feature either CML or ECL or PECL, LVPECL, RSPECL output drivers making them compatible with LVDS input drivers.

FIG. 3 represents an exemplary embodiment of an implementation of the passive processing circuit 20. Passive processing circuit 20 comprises transmission lines 34, 36 and a delay line 38.

Transmission lines are electric lines having a specific length and an end resistance. As shown by lines propagation theory, by using a proper end resistance the input pulse is reflected back with an inverse polarity, and, by choosing a line length such that the delay it introduces is substantially equal to half the rising time of the input pulse, the input pulse and the reflected pulse can combine into a single waveform, herein called a twinset signal.

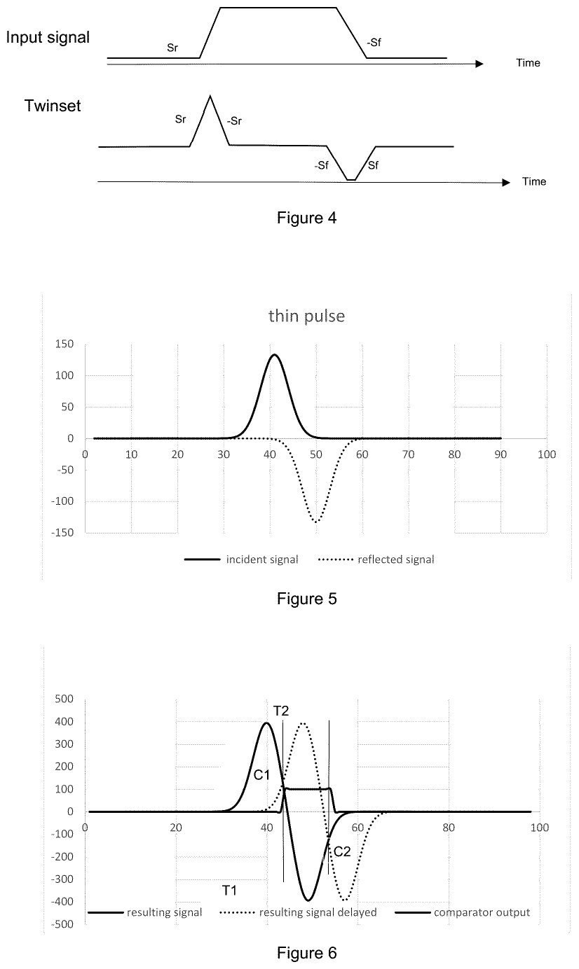

To better understand the notion of twinset signal, reference will now be made to FIGS. 4 to 9.

As shown on FIG. 4, an input signal has a first ramp with a fixed upward slope Sr, a plateau, and a second ramp with a fixed downward slope −Sf. This input signal is typically representative of the ideal pulses that are emitted at the output of photodetector 6. Based on this input signal, a twinset signal is a linear combination of two symmetrical pulses with opposite polarity. The first pulse of the twinset is a ramp up with a fixed upward slope Sr followed by a ramp down with a fixed downward slope −Sr, with the instant trigger of the ramp up being the same as that of the first ramp input signal. The second pulse of the twinset is a ramp down with a fixed downward slope −Sf followed by a ramp up with a fixed upward slope Sf, with the instant trigger of the ramp down being the same as that of the second ramp of the input signal. As explained above, the second pulse is a reflection of the first pulse at the end of the transmission line.

The shape of the twinset signal is not dependent on the pulse width. However, the pulse width is defined by the time lapse between the first positive peak of the twinset signal (corresponding to the pulse rise) and the second negative peak of the twinset signal (corresponding to the pulse fall).

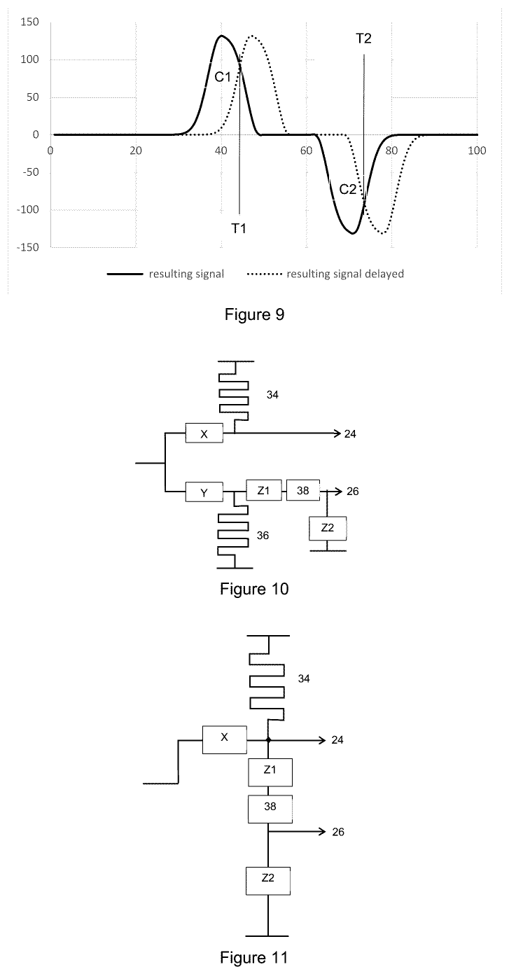

The units shown on FIGS. 5 to 9 are arbitrary. FIG. 5 shows the twinset return pulse signal (positive alternance) obtained from an input signal having a more real life-like shape and it's reflected part by the transmission line termination (negative alternance) whose linear combination is the herein called twinset signal, and FIG. 6 shows the representation of the two twinset signals 24 and 26 delayed with respect to one another by the respective transmission lines 34 and 36 and the delay line 38. In both FIG. 5 and FIG. 6, an input pulse having a shorter pulse width is used, for example 0.5 ns. FIG. 5 shows the effect of varying the amplitude of the incident pulse of FIGS. 5 and 6. FIG. 8 and FIG. 9 correspond respectively to FIG. 5 and to FIG. 6, but with an input pulse having a larger pulse width, for example 10 ns. Alternatively, these values may be of the magnitude of the nanosecond for a shorter pulse and of the magnitude of several nanoseconds for the larger pulse. Generally speaking, the ratio between the larger and the shorter pulse is between 3 and 10.

As appears on FIG. 6 and on FIG. 8, the two twinset curves intersect twice—once in the part of the twinset signal corresponding to the pulse rise (referenced C1), and once in the part of the twinset signal corresponding to the pulse fall (referenced C2).

The time instant T1 at which voltage cross point C1 occurs represents the rising edge time position of the input pulse, whereas the time instant T2 at which voltage cross point C2 occurs represents the falling edge time position of the input pulse.

The Applicant's research has shown that T1 is independent from the input pulse level, width and offset level, whereas T2 is independent from the input pulse level and offset level, and follows the falling edge time position of the input pulse. Consequently, the time difference between the time instants T1 and T2 corresponds exactly to the pulse width.

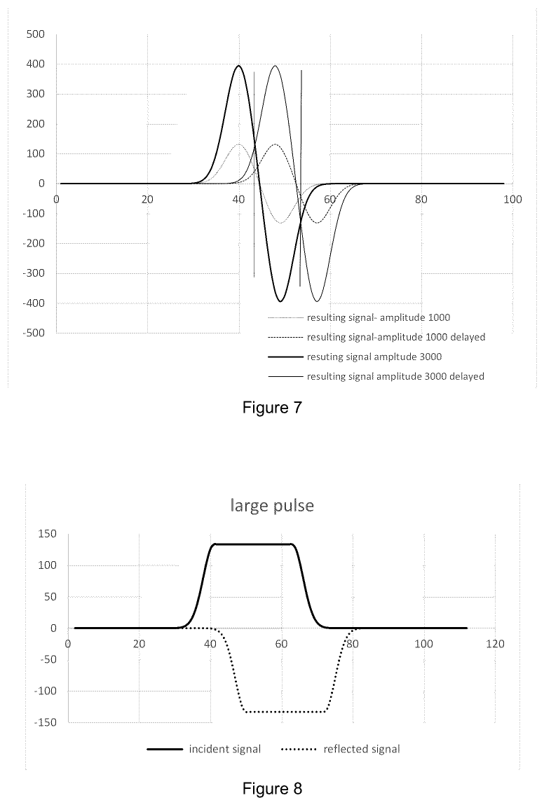

The voltage cross points C1 and C2 between the two twinset curves thus bring an almost noise free information about the input pulse time position and input pulse width as well. Hence, determining time instants T1 and T2 allows to obtain the pulse width with an extreme precision, regardless of the signal amplitude, as shown on FIG. 7. Furthermore, the time instant T2 information reflects the input signal distortion, depending on how strong a laser signal is reflected by a given albedo target and provides a high dynamic luminance information.

In practice, the time instants T1 and T2 are determined by the comparator 22. In order to optimize this determination by the comparator 22, the delay of delay line 38 should be adjusted in a way the two twinset voltages 24 and 26 at the inputs of the comparator 22 cross together versus time with the maximum opposite slope, resulting in high precision and low distortion.

The transmission lines can be realized by means of a single track (microstrip or stripline) or by means of discrete parts as capacitors and inductances. Input and terminal matching impedances can be realized with passive discrete parts if they are not null, or else with a direct connection to ground. This allows to have a very small footprint for this passive processing circuit allowing for a real miniaturization of the EDM function.

For example, on a board having a permittivity of 4.6, a track of 18 cm can be used to provide a transmission line inducing a twinset signal for input pulses having a pulse width of 2 ns, a track of 9 cm can be used to provide a transmission line inducing a twinset signal for input pulses having a pulse width of Ins, and a track of 4.5 cm can be used to provide a transmission line inducing a twinset signal for input pulses having a pulse width of 0.5 ns.

In the same manner, a delay line can be provided using inductance/capacitor cells in series. For example, a 425 ps delay line can be implemented with four consecutive cells having respective inductance and capacitor values of 3.5 nH/2.8 pF, 7 nH/2.8 pF, 7 nH/2.8 pF and ending with a 3.5 nH inductance.

In FIG. 3, elements X and Y are passive electrical elements arranged to perform impedance matching for the transmission lines 34 and 36. They can be optional, and are present when needed in order to prevent multiple reflections. Such multiple reflections may indeed degrade the twinset performance in certain conditions.

A first advantage of this solution is that as compared to former ones, the distance measurement response is extremely flat over the whole luminance amplitude range, improving it by a factor 2 or 3 over the existing solutions, and the standard deviation of this measurement is improved by a factor of 2 over the existing solutions.

The Applicant considers that the explanation for the low standard deviation is that there is no active noise induced by active components since the design is made only with passive components, thus ensuring a negligible contribution to overall noise. Moreover, the symmetrical configuration acts as a pair of differentials lines thus ensuring an immunity to external noise up to high frequencies which are preliminary filtered.

Furthermore, the first twinset and the second delayed twinset are designed to intersect with opposite and very steep slopes, which further lowers the influence of amplitude noise on the cross-point time position measurement by the comparator circuit 22.

Last, the Applicant considers that the distortion reduction of distance measurement results from the fact that the rising edge is compared to itself after inversion (the same applying to the falling edge), and that these signals are well correlated thanks to symmetry and passive design.

Another advantage is that the comparator toggles again on the falling edge of the pulse, giving the pulse width, provided the transmission lines 34 and 36 respective load resistance are slightly shifted with respect to one another. This may be done by introducing a load resistor at the transmission line 36 termination whereas the transmission line 34 termination is tied to ground.

Other advantages include that the invention is suitable for any pulse width and a large range of symmetrical enough shapes and that the output of the comparator 22 is a binary step trigger thus suitable for digital interface as well as for TDC (Time to Digital Converter).

Output step time position is almost insensitive to the input level variations in the linear range of electronics part when there is no saturation. When the input pulse begins to reach a saturation level, the pulse width increases moving from a low width to a large width, but, as shown in FIGS. 5 to 9 this doesn't affect the determination of the time instant T1 provided the slope also saturates, while the determination of the time instant T2 is delayed, thus offering a way to measure luminance information in this saturated mode.

The comparator 22 propagation delay is minimized; and the distortion correction error is minimized. The comparator 22 output is insensitive to signal rebounds since eventual rebounds are drowned in the negative alternation of one or the other shifted peak of the twinset. Also, since the input noise is also fairly low due to the fully passive implementation, it further has a very low impact on the comparator 22 output jitter. Finally, the comparator 22 output first toggling, corresponding to time instant T1, is insensitive to return pulse level variation, and the walk time due to pulse trailing edge or pulse width variations is limited.

The embodiment of FIG. 3 further ensures that the resulting first twinset and second delayed twinset are prepared to be compared simultaneously. The comparison result is a “digital” step signal produced in real time. The first peak of the twinset signal brings time position information on its leading edge, the second peak of the twinset signal brings time position information on its trailing edge, and the interval between both signals brings input signal saturation level and somewhat luminance information for saturated signals.

As a result, the comparison circuit of the invention can be made quite inexpensive, all the while performing at a much higher performance level than existing solutions.

FIGS. 10 and 11 show two other possible embodiments for the passive processing circuit 20.

According to the embodiment of FIG. 10, delay line 38 is placed downstream of the transmission line 36, and additional impedance matching elements Z1 and Z2 may be added for the impedance matching of delay line 38. This design allows to be more adaptable to all situations, as each of transmission lines 34 and 36 and delay line 38 may receive its impedance matching element. It is also more costly and complicated to tune.

According to the embodiment of FIG. 11, transmission line 36 is omitted and only transmission line 34 is kept. Delay line 38 is used to compare the twinset signal from transmission line 34 with itself. As a result, only elements X, Z1 and Z2 may be added for impedance matching purposes. This embodiment is a simpler topological alternative than that of the embodiments of FIGS. 3 and 10, but it is also a little more noise prone.

1. Electronic distance meter comprising:
a laser emitting a laser pulse toward a target,
a photodetector adapted for receiving a laser pulse reflected by the target and for outputting a corresponding return pulse signal, and
a comparison circuit receiving said return pulse signal and comprising a passive signal processing circuit and a comparator provided with a first input and a second input and arranged to output a first fixed value signal when the signal at the first input exceeds the signal at the second input and else to output a second fixed value signal, said comparison circuit being arranged for determining a return pulse time signal based on the output of said comparator, said electronic distance meter being arranged for determining a target distance based on said return pulse time signal, wherein said passive signal processing circuit comprises a first branch receiving said return pulse signal and comprising a transmission line for generating a first twinset signal to said first input, and a second branch receiving said return pulse signal and comprising a transmission line and a delay line for generating a second twinset signal to said second input, the transmission lines being chosen such that each twinset signal respectively comprises a positive and negative alternating portion which substantially corresponds to a first order derivative of the return pulse signal.

2. Electronic distance meter according to claim 1, wherein said delay line has a delay value chosen such that the rising edge of the signal of said transmission line of said second branch crosses the trailing edge of the signal of said transmission line of said first branch in a region.

3. Electronic distance meter according to claim 1, wherein said transmission lines are realized by means of a single track or by means of discrete parts.

4. Electronic distance meter according to claim 3, wherein said single track includes a microstrip or a stripline and said discrete parts include capacitors and inductances.

5. Electronic distance meter according to claim 1, wherein said delay line is realized by means of inductance-capacitor cells connected in series.

6. Electronic distance meter according to claim 1, wherein said first branch comprises a passive element (X) for impedance matching of the transmission line.

7. Electronic distance meter according to claim 1, wherein said second branch comprises a passive element (Y) for impedance matching of the transmission line.

8. Electronic distance meter according to claim 1, wherein said second branch comprises passive elements (Z1, Z2) for impedance matching of the delay line.

9. Electronic distance meter according to claim 1, wherein said delay line has a delay value chosen such that the rising edge of the signal of said transmission line of said second branch crosses the trailing edge of the signal of said transmission line of said first branch in a region where both the rising edge and the trailing edge have substantially a maximum first order derivative.

10. Method for measuring a distance, comprising:
a) emitting a laser pulse toward a target,
b) generating a return pulse signal based on a laser pulse reflected by the target,
c) generating a first twinset signal and a second twinset signal derived from the return pulse signal, using a transmission line for said first twinset signal, and using a transmission line and a delay line for said second twinset signal, said transmission lines being chosen such that each twinset signal respectively comprises a positive and negative alternating portion which substantially corresponds to a first order derivative of the return pulse signal,
d) generating a return pulse time signal based on a comparison between said first twinset signal and said second twinset signal, said return pulse time signal being equal to a first fixed value when said first twinset signal exceeds said second twinset signal and equal to a second fixed value otherwise, and
e) determining a target distance based on said return pulse time signal.

11. Method according to claim 10, wherein in operation c) said delay line has a delay value chosen such that the rising edge of the signal of said transmission line of said second branch crosses the trailing edge of the signal of said transmission line of said first branch in a region.
